(19) United States
(12) Patent Application Publication
(10) Pub. No.: US 2005/0148230 A1
(43) Pub. Date: Jul. 7, 2005

(54) Coupling device that includes opposing pawls engagable into opposing pawl catches

(76) Inventor: James Donald Flynn, Auburn, WA (US)

Correspondence Address: LOOP INTELLECTUAL PROPERTY LAW PLLC, P.O. BOX 21466, SEATTLE, WA, 98111, US

(21) Appl. No.: 10/835,873

(22) Filed: Apr. 29, 2004

Related U.S. Application Data
(60) Provisional application No. 60/534,637, filed on Jan. 7, 2004.

(51) Int. Cl. H01R 13/627

(52) U.S. Cl. 439/358

(57) ABSTRACT

Disclosed herein are coupling and connecting devices that include confronting opposite side walls engagable with opposing outwardly biased leaf springs, wherein the side walls and leaf springs further include pawls engagable into opposing pawl catches. In one embodiment, the invention is directed to a coupler that comprises a receptacle and a complementary plug (meaning that the plug is insertable into the receptacle). The receptacle includes confronting opposite side walls that define a plug space therebetween, wherein each side wall includes a laterally inwardly directed first connector component. The plug has opposite sides, wherein each side has a laterally outwardly directed second connector component. One of the first and second connector components is a pawl and the other is a pawl catch. In addition, the insertion of the plug into the receptacle will move the pawls past the pawl catches and into a position in which the pawls and pawl catches mate and together resist unintended removal of the plug away from the receptacle. The opposite sides of the plug are in the nature of laterally outwardly biased leaf springs adapted to bias the pawls into the pawl catches. The leaf springs are movable together for removing the pawls from the pawl catches and allowing the plug to be withdrawn from the receptacle.

### CROSS-REFERENCE TO RELATED APPLICATION

This application claims to benefit of priority to U.S. Provisional Patent Application No. 60/534,637 filed on Jan. 7, 2004, which application is incorporated herein by reference in its entirety for all purposes.

### TECHNICAL FIELD

The present invention relates generally to coupling devices and, more specifically, to couplers and connecting devices for electrically conjoining cables or conductive elements together. The couplers and connecting devices generally include confronting opposite side walls engagable with opposing outwardly biased leaf springs, wherein the side walls and leaf springs further include pawls engagable into opposing serrated pawl catches.

### BACKGROUND OF THE INVENTION

The coupling or connecting of a first article together with a second article by means of specialized plugs and receptacles is known in the art. For example, and in the context of electrical connections, there are several different kinds of known male and female connectors that have been specially configured to securely engage or mate with each other, thereby electrically connecting one component with the other. In particular, there are male and female connectors known in the art for securely engaging a pin component at one end of a first cable (e.g., computer cable) together with a complementary socket component at one end of a second cable or other appropriate interface (e.g., computer cable or hardware device).

FIG. 1 illustrates a first connecting device in accordance with the prior art. As shown, the first prior art connecting device includes a male plug engaged into a female receptacle, wherein the plug and receptacle are secured together by means of wire loops latched to complementary catch components. The latching of wire loops does not generally provide for a very robust or securely fastened connection between the coupled components.

FIG. 2 illustrates a second connecting device in accordance with the prior art. As shown, the second prior art connecting device includes a male plug engaged into a female receptacle, wherein the plug and receptacle are secured together by means of threaded screws that engage complementary screw holes. The tightening and loosening of threaded screws, however, is often cumbersome and time consuming, especially if there are space constraints associated with the connecting activity.

Accordingly, there is still a need in the art for new and improved couplers and connection devices and, more specifically, there is a need for couplers and connectors for securely and electrically connecting a first part of a first element together with a second part of a second element. The present invention fulfills these needs and provides for further related advantages.

### BRIEF DESCRIPTION OF THE DRAWINGS

Like reference numerals are used to designate like features throughout the several views of the drawings, and:

FIG. 1 is a pictorial view of a first connecting device having wire loops latched to complementary catch components in accordance with the prior art;

FIG. 2 is a pictorial view of a second connecting device having threaded screws that engage complementary threaded screw holes in accordance with the prior art;

FIG. 3 is a pictorial view of a coupler in accordance with an embodiment of the present invention, wherein the coupler includes a receptacle having confronting opposite side walls and a plug insertable into the receptacle;

FIG. 4 is a pictorial view of a coupler in accordance with an embodiment of the present invention, wherein the coupler includes a receptacle having confronting opposite side walls and a plug inserted into the receptacle;

FIG. 5 is a top view of the coupler illustrated in FIG. 4;

FIG. 6 is an enlarged view of a portion of the coupler illustrated in FIG. 5, wherein a pawl is engaged with a pawl catch and together resist unintended removal of the plug away from the receptacle in accordance with an embodiment of the present invention;

FIG. 7 is an orthographic projection of one of the side walls and connector components in accordance with an embodiment of the present invention; and

FIG. 8 is an orthographic projection of one of the leaf springs and second connector components in accordance with an embodiment of the present invention.

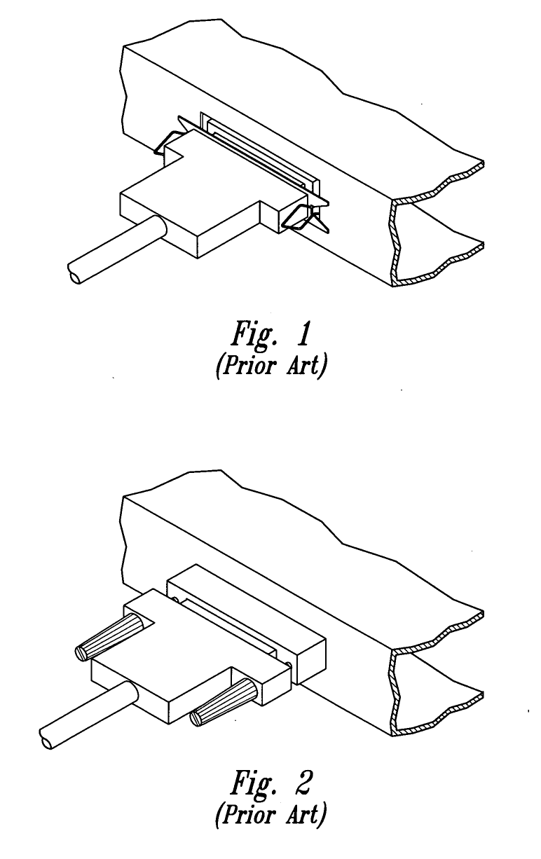

### SUMMARY OF THE INVENTION

In brief, the present invention is directed to couplers and connecting devices that include confronting opposite side walls engagable with opposing outwardly biased leaf springs, wherein the side walls and leaf springs further include pawls engagable into opposing serrated pawl catches. Thus, and in one embodiment, the present invention is directed to a coupler that comprises a receptacle and a complementary plug (meaning that the plug is insertable into the receptacle). The receptacle includes confronting opposite side walls that define a plug space therebetween, wherein each side wall includes a laterally inwardly directed first connector component. The plug has opposite sides, wherein each side has a laterally outwardly directed second connector component. One of the first and second connector components is a pawl and the other is a pawl catch. In addition, the insertion of the plug into the receptacle will move the pawls past the pawl catches and into a position in which the pawls and pawl catches mate and together resist unintended removal of the plug away from the receptacle. The opposite sides of the plug are in the nature of laterally outwardly biased leaf springs adapted to bias the pawls into the pawl catches. The leaf springs are movable toward each other for removing the pawls from the pawl catches and allowing the plug to be withdrawn from the receptacle.

In other embodiments, the coupler may further comprise a plurality of pawl catches arranged in series (e.g., serrated with a plurality of notches together with interposing teeth) in the direction of plug movement into and out from the receptacle. In addition, the leaf springs may have outer end portions that function as handles that can be squeezed toward each other for bending the leaf springs and moving the pawls away from the pawl catches.

In still further embodiments, the coupler may further comprise a pin component at a first end of a first element and a complementary socket component at a second end of a second element, wherein the pin component includes a plurality of pins and the socket component includes a plurality pin receiving sockets, and wherein when the pins are in the pin receiving sockets the plug is in the receptacle and the pawls are in the pawl catches.

These and other aspects of the present invention will become more evident upon reference to the following detailed description and attached drawings. It is to be understood, however, that various changes, alterations, and substitutions may be made to the specific embodiments disclosed herein without departing from their essential spirit and scope.

### DETAILED DESCRIPTION OF THE INVENTION

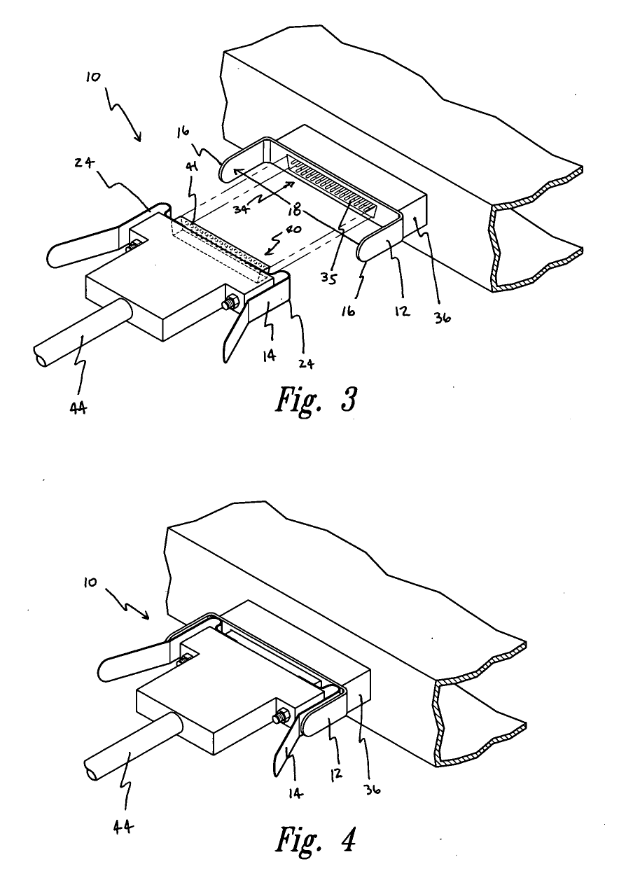

As noted above, the present invention is directed to couplers and connecting devices that include confronting opposite side walls engagable with opposing outwardly biased leaf springs, wherein the side walls and leaf springs further include pawls engagable into opposing pawl catches. In some embodiments, the present invention is directed to couplers and connecting devices having the configuration and connector components described and illustrated herein. Thus, and in order to provide a better understanding of certain embodiments of the present invention, many specific details of such embodiments are set forth in the following description and in FIGS. 3-8. Those skilled in the art, however, will understand that the present invention may have additional embodiments and that the invention may be practiced without several of the details described below or shown in the accompanying drawings.

Thus, and referring generally to FIGS. 3 through 8, the present invention in one embodiment is directed to a coupler 10 that comprises a female receptacle 12 and a complementary male plug 14. As shown in FIGS. 3 through 6, the plug 14 is insertable and inserted into and engaged with the receptacle 12. Those skilled in the art will appreciate, however, that the plug 14 is generally readily detachable from the receptacle 12 when in an inserted position. As further shown, the receptacle 12 includes confronting opposite side walls 16 that define a plug space 18 between them. Each side wall 16 includes a laterally inwardly directed first connector component 20. In one preferred embodiment, the first connector components 20 of each side wall 16 include serrated pawl catches 22 embossed on inwardly directed portions of the side walls 16, wherein the serrate pawl catches 22 include a plurality of notches 21 and a plurality of interposing teeth 23; however, the first connector components 20 may be pawls (not shown) that protrude away from the side walls 16. Similarly, the plug 14 includes opposite sides that are in the nature of laterally outwardly biased leaf springs 24. Each side or leaf spring 24 includes a laterally outwardly directed second connector component 26. In one preferred embodiment, the second connector components 26 of each leaf spring 24 include a pawl 28 that extends away from outwardly directed faces 25 of the opposite leaf springs 24; however, the second connector components 26 may be serrated pawl catches (not shown) embossed on the outwardly directed faces 25 of the leaf springs 24.

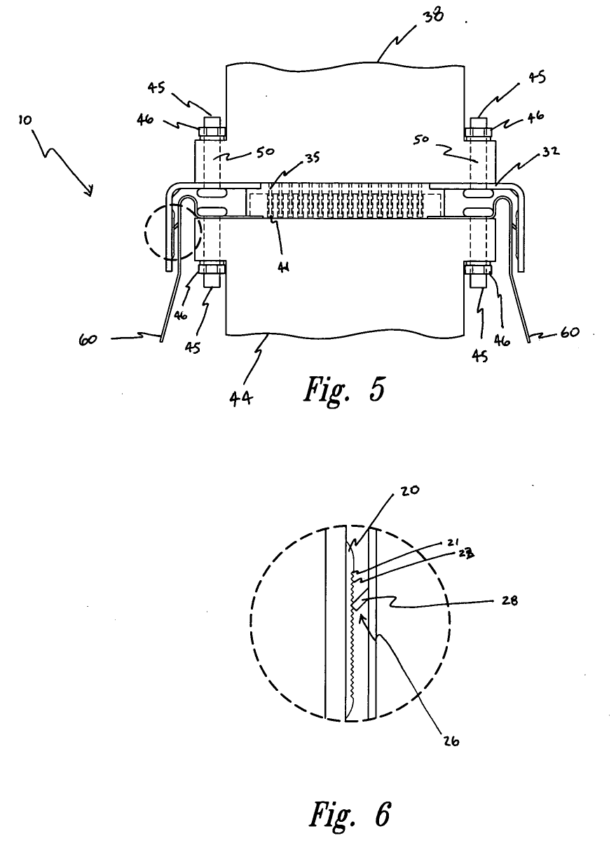

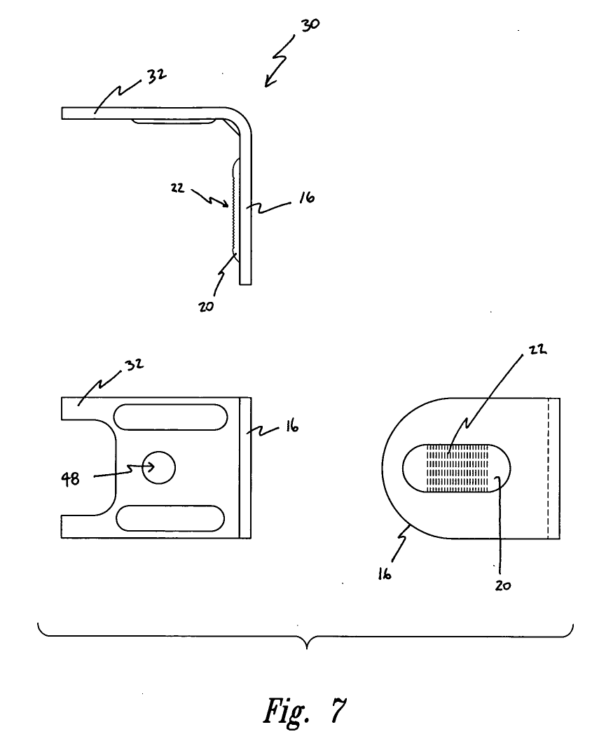

As best shown in the orthographic projection of FIG. 7, each side wall 16 of the receptacle 12 component of the present invention may be part of a right-angled bracket 30. The right-angled bracket 30 preferably includes a base portion 32 that is adapted for attachment to either (1) a pin component 34 at a first end 36 of a first element 38 (e.g., a male end of a first computer cable), or (2) a complementary socket component 40 at a second end 42 of a second element 44 (e.g., a female end of a second computer cable or other like interface). As best shown in FIG. 5, the base portion 32 of the right-angled bracket 30 may be attached to the pin component 34 or complementary socket component 40 by means of threaded nuts 45 and bolts 46, wherein one of the threaded bolts 46 passes through a central hole 48 located in the base portion 32 and also through a peripheral hole 50 located at one of two side portions 52 of the pin component 34 or of the complementary socket component 40. Each side wall 16 and base portion 32 that make up each right-angled bracket 30 are preferably formed from a single strip of steel, namely, a single strip of 300 series full hard steel having approximate dimensions of about 0.040 inches thick by about 0.50 inches wide by about 1.285 inches long.

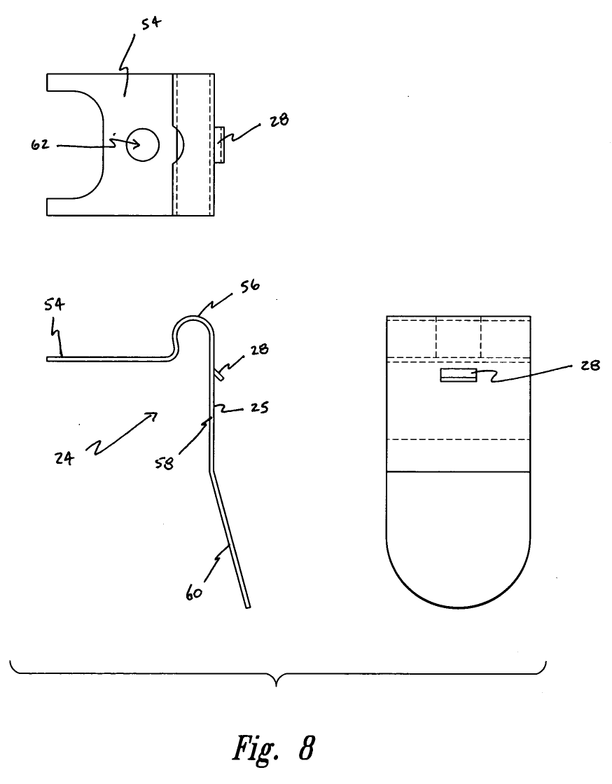

Similarly, and as best shown in the orthographic projection of FIG. 8, each side or leaf spring 24 of the plug 14 component of the present invention may be part of a specially configured contiguous strip of spring metal. As shown, each spring metal strip (that comprise the leaf springs 24) generally includes a leaf spring base portion 54, a curved spring portion 56, a straight side portion 58, and an outwardly bent handle portion 60. As with the right-angled bracket base portion 32, the leaf spring base portion 54 is adapted for attachment to either (1) a pin component 34 at a first end 36 of a first element 38 (e.g., a male end of a first computer cable), or (2) a complementary socket component 40 at a second end 42 of a second element 44 (e.g., a female end of a second computer cable or other like interface). As best shown in FIG. 5, the leaf spring base portion 54 may be attached to the pin component 34 or complementary socket component 40 by means of threaded nuts 45 and bolts 46, wherein one of the threaded bolts 46 passes through a central hole 62 located in the leaf spring base portion 54 and also through a peripheral hole 50 located at one of two side portions 52 of the pin component 34 or of the complementary socket component 40. The leaf spring base portion 54, the curved spring portion 56, the straight side portion 58, and the outwardly bent handle portion 60 are preferably formed from a single strip of spring steel, namely, a single strip of 1095 series spring steel having approximate dimensions of about 0.015 inches thick by about 0.50 inches wide by about 1.69 inches long.

Thus, and when the plug 14 and receptacle 12 are appropriately attached to their corresponding pin and socket components 34, 40, the coupler 10 of the present invention is adapted for electrically conjoining the first element 38 together with the second element 44. In this regard, the pin component 34 includes a plurality of pins 35 and the socket component 40 includes a plurality of pin receiving sockets 41. Importantly, when the pins 35 are in the pin receiving sockets 41 the plug 14 is in and engaged with the receptacle 12, and the pawls 28 are in and engaged with the pawl catches 22. Moreover, the insertion of the plug 14 into the receptacle 12 will move the pawls 28 past the pawl catches 22 and into a position in which the pawls 28 and pawl catches 22 mate and together resist unintended removal of the plug 14 away from the receptacle 12. The handle portions 60 of the leaf springs 24 are movable toward each other for removing the pawls 28 from the pawl catches 22 and allowing the plug 14 to be withdrawn from the receptacle 12.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

1. A coupler, comprising:
a receptacle including confronting opposite side walls that define a plug space between them, each side wall having a laterally inwardly directed connector component;
a plug insertable into the receptacle, said plug having opposite sides, each side having a laterally outwardly directed second connector component;
wherein one of said connector components is a pawl and the other is a pawl catch;
wherein insertion of the plug into the receptacle will move the pawls past the pawl catches and into a position in which the pawls and pawl catches mate and together resist unintended removal of the plug away from the receptacle; and
wherein the opposite sides of the plug are in the nature of laterally outwardly biased leaf springs adapted to bias the pawls into the pawl catches, said leaf springs being movable together for removing the pawls from the pawl catches and allowing the plug to be withdrawn from the receptacle.

2. The coupler of claim 1 wherein one of said connector components further comprises a plurality of pawl catches arranged in series in the direction of plug movement into and out from the receptacle.

3. The coupler of claim 1 wherein the leaf springs have outer end portions that function as handles and said handles can be squeezed together for bending the leaf springs and moving the pawls away from the pawl catches.

4. The coupler of claim 1, further comprising a pin component at one end of a first element and a complementary socket component at one end of a second element, wherein the pin component includes a plurality of pins and the socket component includes a plurality of pin receiving sockets, and wherein when the pins are in the pin receiving sockets the plug is in the receptacle and the pawls are in the pawl catches.

5. The coupler of claim 4 wherein the first element is a first cable and the second element is a second cable.

6. The coupler of claim 1 wherein each leaf spring is made of spring steel.

7. The coupler of claim 1 wherein each side wall is part of a right-angled bracket.

8. A connection device for electrically connecting a first part of a first element with a second part of a second element, said connection device comprising:
a female receptacle including confronting opposite side walls that define a plug space therebetween, wherein each side wall includes a laterally inwardly directed first connector component;
a male plug insertable into the female receptacle, wherein said male plug includes opposite sides, and wherein each side includes a laterally outwardly directed second connector component;
wherein one of said connector components is a pawl and the other is a pawl catch;
wherein insertion of the male plug into the female receptacle moves the pawls past the pawl catches and into a position in which the pawls and pawl catches mate and together resist unintended removal of the male plug away from the female receptacle; and
wherein the opposite sides of the male plug are defined by laterally outwardly biased leaf springs adapted to bias the pawls into the pawl catches, wherein said leaf springs are movable toward each other for removing the pawls from the pawl catches and allowing the male plug to be withdrawn from the female receptacle.

9. The connection device of claim 8 wherein one of said connector components further comprises a plurality of pawl catches arranged in series in the direction of male plug movement into and out from the female receptacle.

10. The connection device of claim 8 wherein the leaf springs have outer end portions that function as handles and said handles can be forced toward each other for bending the leaf springs and moving the pawls away from the pawl catches.

11. The connection device of claim 8 wherein the first conductive part of the first element is a pin component attached at one end of the first element, and wherein the second conductive part of the second element is a complementary socket component attached at one end of the second element, wherein the pin component includes a plurality of pins and the socket component includes a plurality of pin receiving sockets, and wherein when the pins are in the pin receiving sockets the male plug is in the female receptacle and the pawls are in the pawl catches.

12. The connection device of claim 8 wherein the first element is a first cable and the second element is a second cable.

13. The connection device of claim 8 wherein each leaf spring is made of spring steel.

14. The connection device of claim 8 wherein each side wall is part of a right-angled bracket.
